(19) United States
(12) Patent Application Publication
(10) Pub. No.: US 2012/0084102 A1
(43) Pub. Date: Apr. 5, 2012

(54) Systems and Methods for Electronic Insurance Policy Delivery

(76) Inventor: William Atlee, Exton, PA (US)

(21) Appl. No.: 12/898,086

(22) Filed: Oct. 5, 2010

(51) Int. Cl. G06Q 40/00

(52) U.S. Cl. 705/4

(57) ABSTRACT

A system and method in which data regarding an insurance policy to be presented to a consumer for review and execution is stored in one or more databases. The consumer is presented with one or more electronic messages indicating that the insurance policy is available for review and inquiring as to whether the consumer agrees to review and execute the policy in electronic form. After receiving an electronic indication from the consumer that he agrees to review and execute the policy in electronic form, the policy is presented to the consumer in electronic form. After receiving an electronic indication from the consumer of agreement to review and execute the insurance policy in electronic form, the consumer is electronically presented with one or more options for enhancing the insurance coverage without performing any additional underwriting for the policy.

### BACKGROUND

Traditionally, insurance policies are delivered to a policyholder in paper form, using in person delivery, mail or courier. However, such delivery mechanisms can be slow, inefficient and expensive and, further, do not allow for dynamic interaction with the policyholder at the time of policy issuance. In a multi-tiered distribution environment, such delivery mechanism can be even slower, less efficient and more expensive without allowing for dynamic review of the policy prior to delivery to the policy holder.

### FIELD OF THE INVENTION

The present invention is directed to systems and methods related to electronic review and delivery of insurance policies.

### SUMMARY OF INVENTION

The present invention is further directed to a system and method in which data regarding an insurance policy, providing insurance coverage, to be presented to a consumer for review and execution is stored in one or more databases. The consumer is presented with one or more electronic messages indicating that the insurance policy is available for review and inquiring as to whether the consumer agrees to review and execute the policy in electronic form. After receiving an electronic indication from the consumer of agreement to review and execute the insurance policy in electronic form, the consumer is electronically presented with one or more options for enhancing the insurance coverage without performing any additional underwriting for the policy.

Features and advantages of the invention will be set forth in the description which follows, and in part will be apparent from the description, or may be learned by practice of the invention. The objectives and other advantages of the invention will be realized and attained by the structure particularly pointed out in the written description hereof as well as any of the appended drawings herein.

It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system diagram of an exemplary embodiment of the present invention;

FIG. 2 is a diagram showing steps of an exemplary method of the present invention; and

FIGS. 3-6, 7A-7D, and 8 are exemplary interfaces that may be used in connection with exemplary embodiments of the present invention.

### DETAILED DESCRIPTION OF THE EXEMPLARY EMBODIMENTS

Reference will now be made in detail to the embodiments of the present invention, examples of which are illustrated in the accompanying drawings. While the embodiments and examples described herein relate to life insurance, it will be understood by those skilled in the art that the invention is equally applicable to other types of insurance.

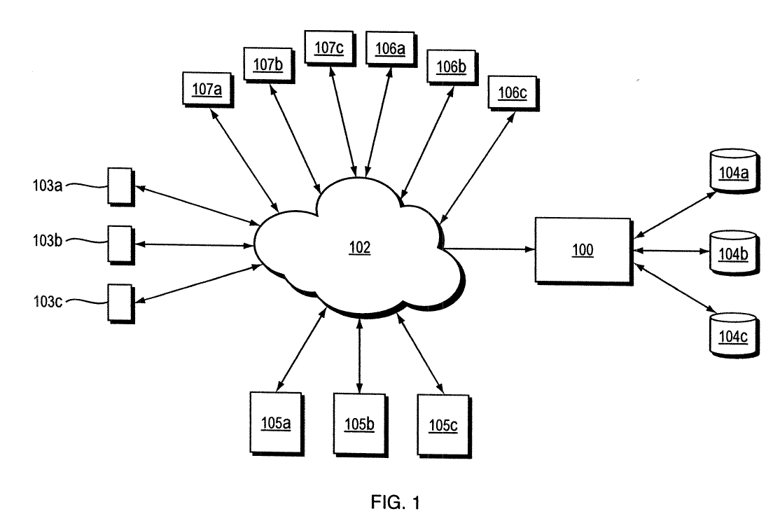

The embodiments described herein relate to systems and methods that allow consumers to access insurance policy information electronically. FIG. 1 illustrates a system diagram of an exemplary embodiment of the present invention. Electronic insurance policy delivery platform 100 is comprised of a number of components that allow for the presentation, delivery and storage of insurance policy information, including insurance policies, electronically. Devices of consumers 103a, 103b, 103c; insurance carriers 105a, 105b, and 105c; distributors 106a, 106b and 106c; and agents 107a, 107b and 107c communicate with platform 100 over communications network 102. While for illustrative purposes three devices for each entity are shown, the embodiments of the invention are not so limited; any suitable number of devices can communicate with platform 100 within the scope of the present invention. Such devices may be any type of communication device such as a computer, cell phone, personal digital assistant (PDA), iPad, and the like. Communications network 102 may be any data communications network, such as point-to-point connection, local area network, wide area network, Intranet, Internet, cellular network, and the like.

Platform 100 is comprised of hardware and software used to carry out the functionality described herein. In particular, such functionality may be executed by one or more servers implemented in hardware and/or software; for example, a server may comprise a programmable computer executing computer programs, which computer includes one or more processors, data storage systems, one or more input devices, and one or more output devices.

Databases 104a, 104b, 104c can be any form of database as will be known to those skilled in the art, such as relational or flat-file databases. Such databases are associated with one or more computer programs that enable the storage, modification and extraction of information from the database. The databases 104a, 104b, 104c may be stored on any suitable computing device. While four databases are represented in FIG. 1, such representation is made for illustration purposes only and the embodiments of the invention are not so limited; any number of databases can be used within the scope of the present invention.

Platform 100 hosts a consumer portal used by client devices 103a, 103b and 103c in connection with accessing insurance policy information electronically, as described in more detail herein. Platform 100 may also host other portals used by insurance carrier devices 105a, 105b, and 105c; distributor devices 106a, 106b and 106c; and agent devices 107a, 107b and 107c to access insurance policy information electronically. Insurance carrier devices 105a, 105b, and 105c may transmit insurance policy information that is to be maintained in connection with platform 100 by way of a data feed.

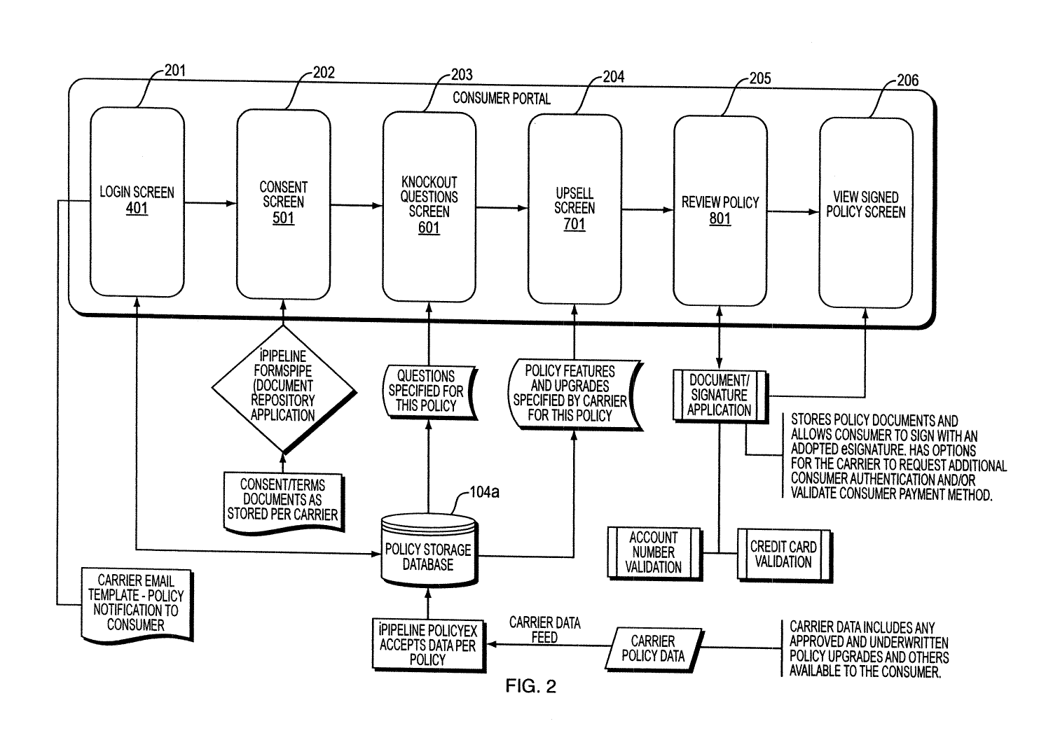

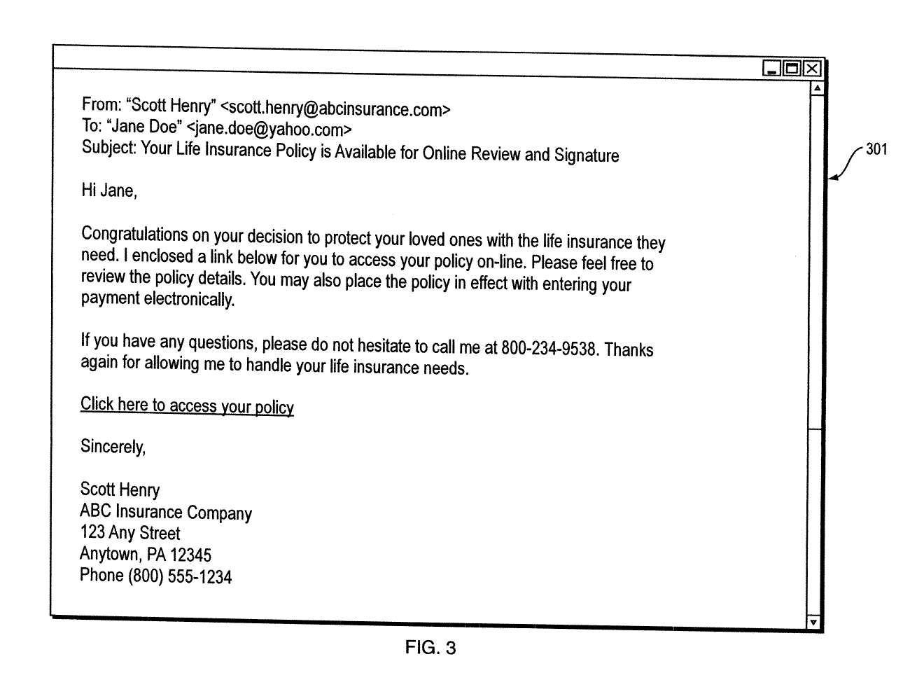

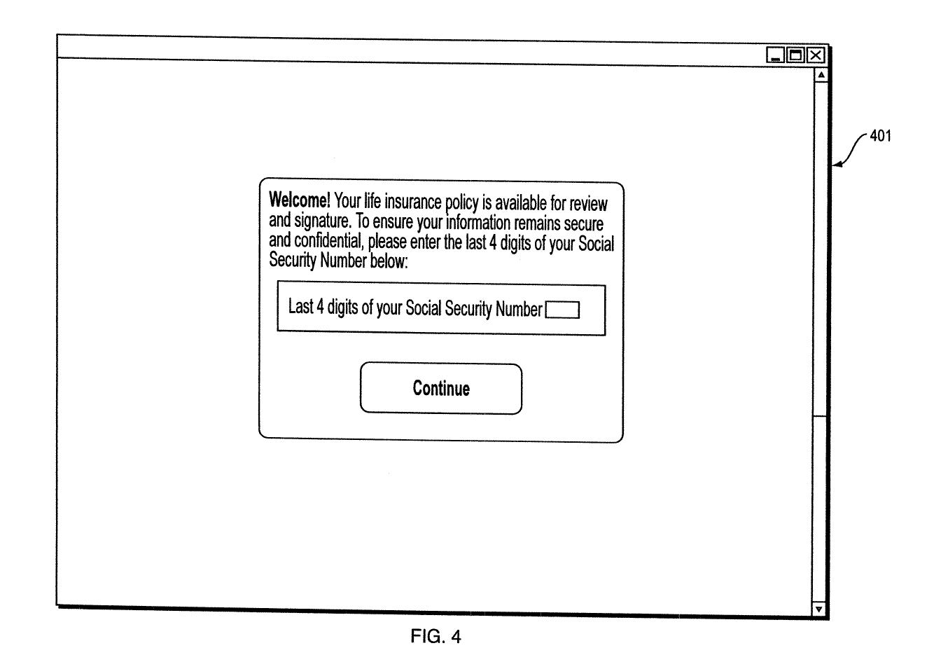

With reference to FIG. 2, a diagram showing certain aspects of an exemplary consumer portal and the manner in which it operates within the system of FIG. 1, is illustrated. After a consumer applies for an insurance policy, the application is approved and the policy is underwritten by an insurance carrier, in step 201, an electronic message 301 is sent to the consumer, as shown in FIG. 3. While the electronic message 301 is shown as an electronic mail message, electronic message 301 may be presented to consumer through other electronic means within the scope of the invention (e.g., by presenting the electronic message to the consumer via an Internet website). Upon clicking the link within the electronic message 301, the consumer is directed to a login screen 401, as shown in FIG. 4. The login screen 401 informs the consumer that his policy is available for review and signature and is asked to supply authentication credentials. Policy storage database (e.g., database 104a of FIG. 1) is consulted to determine whether the appropriate credentials were supplied.

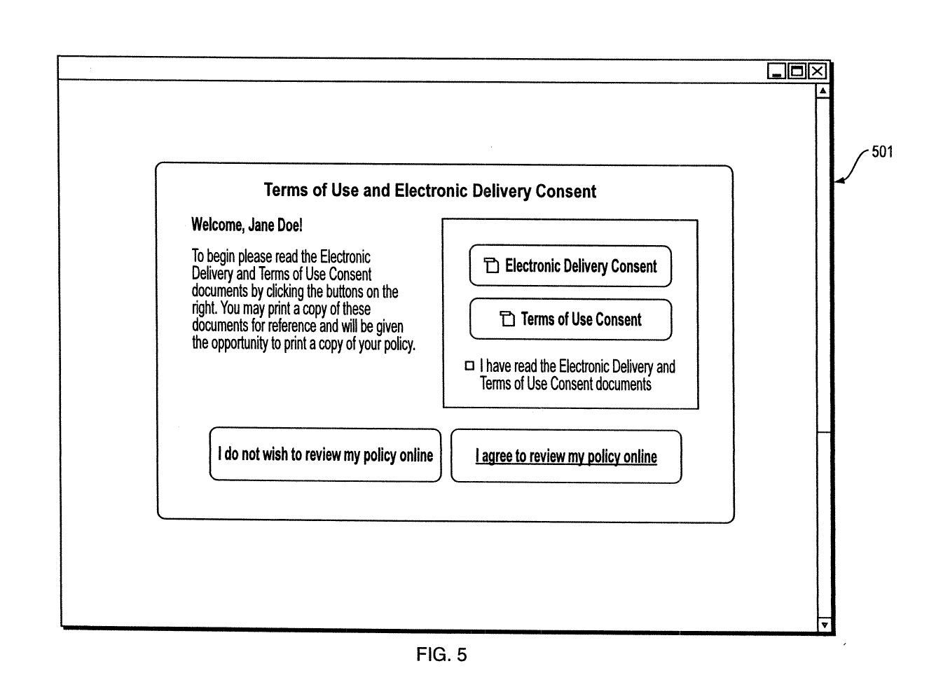

Upon supplying the appropriate credentials, in step 202, a consent screen 501, such as that shown in FIG. 5, is presented. Here, the consumer reviews the electronic delivery consent and terms of use consent supplied by the carrier. The consumer is asked whether he wishes to review his policy online Upon indicating his agreement to the electronic delivery and terms of use consent documents, the consumer may click the section of consent screen 501 indicating his agreement to review his policy online. If the consumer opts out of reviewing and signing his policy online, he will exit the online process and a hard copy of his policy is mailed or delivered in person for review and signature. The electronic delivery and terms of use consent documents as required by each insurance carrier may be stored in connection with platform 100 (e.g., database 104b). The particular documents presented to the consumer for review and agreement are chosen by a document repository application running on platform 100 based on the identity of the carrier from whom the consumer has applied for insurance coverage.

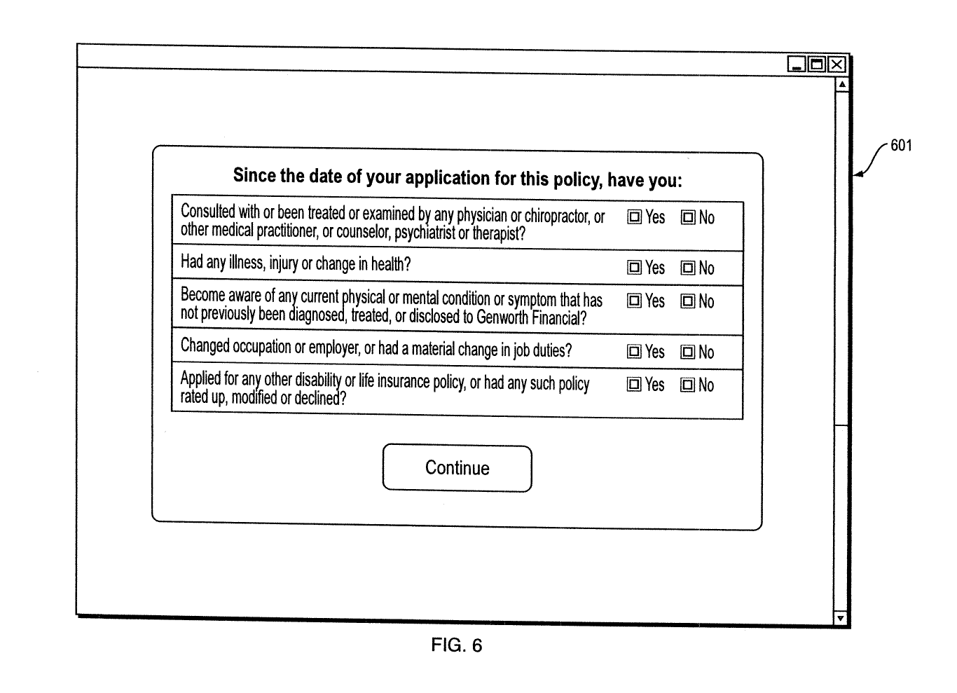

Upon the consumer agreeing to review the policy online, in step 203, knockout questions screen 601, shown in FIG. 6, may optionally be presented. The consumer's responses to the questions may cause policy delivery to be suspended until a further underwriting review is conducted. The questions presented to the consumer are obtained from policy storage database (e.g., database 104a), identified for the policy to be issued, as supplied by the carrier from whom the consumer has applied for insurance coverage.

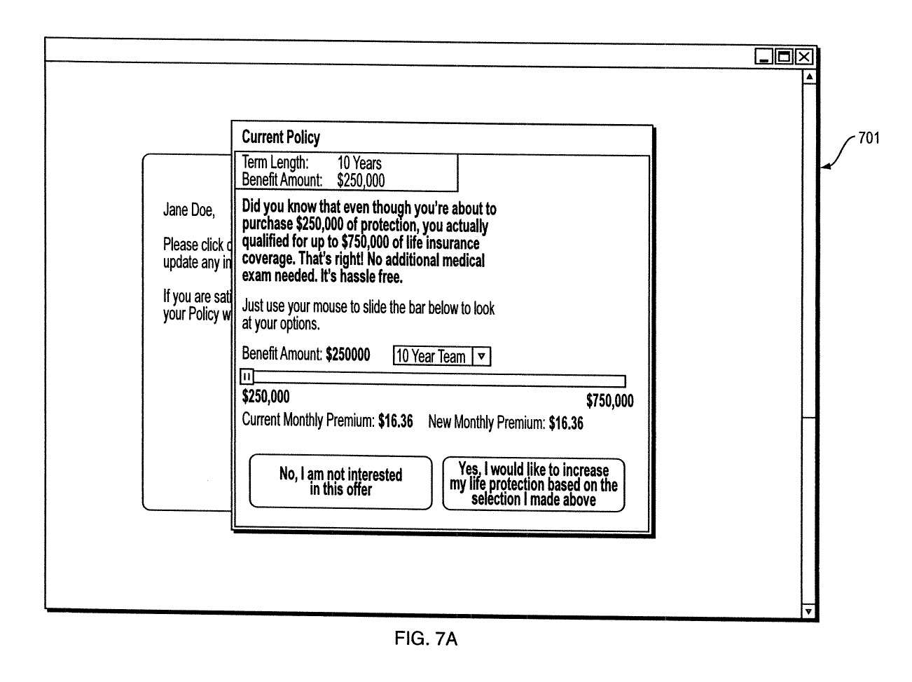

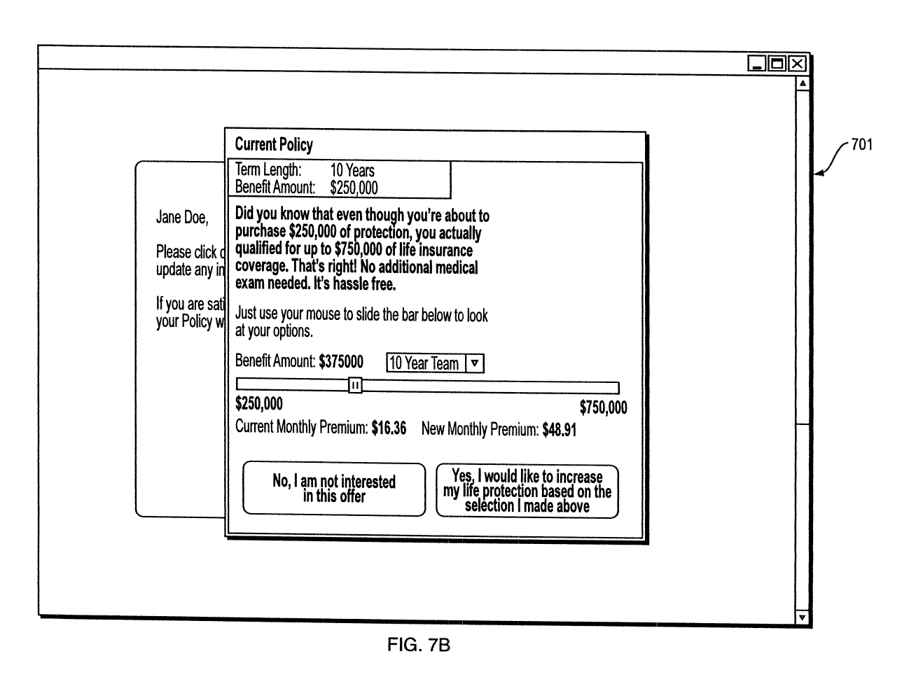

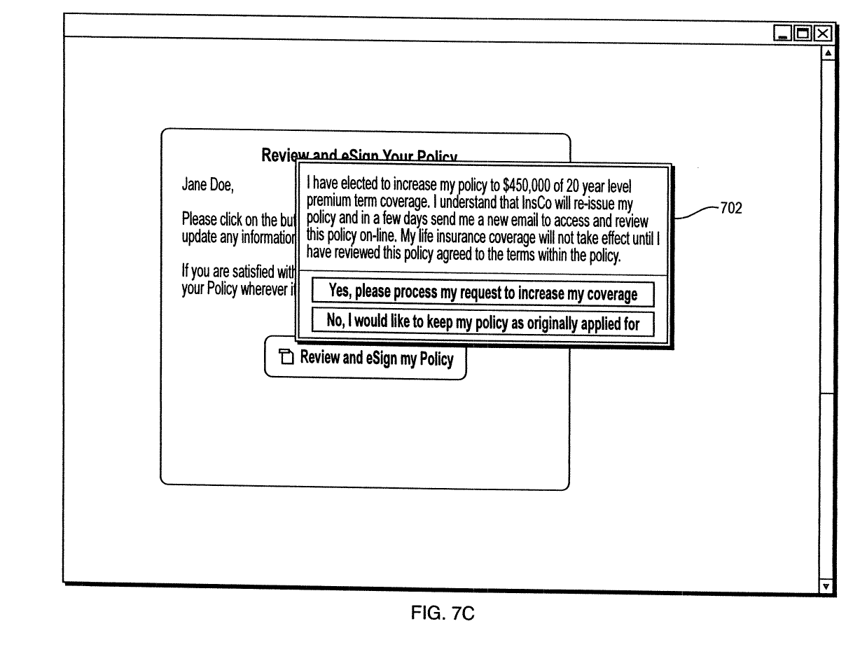

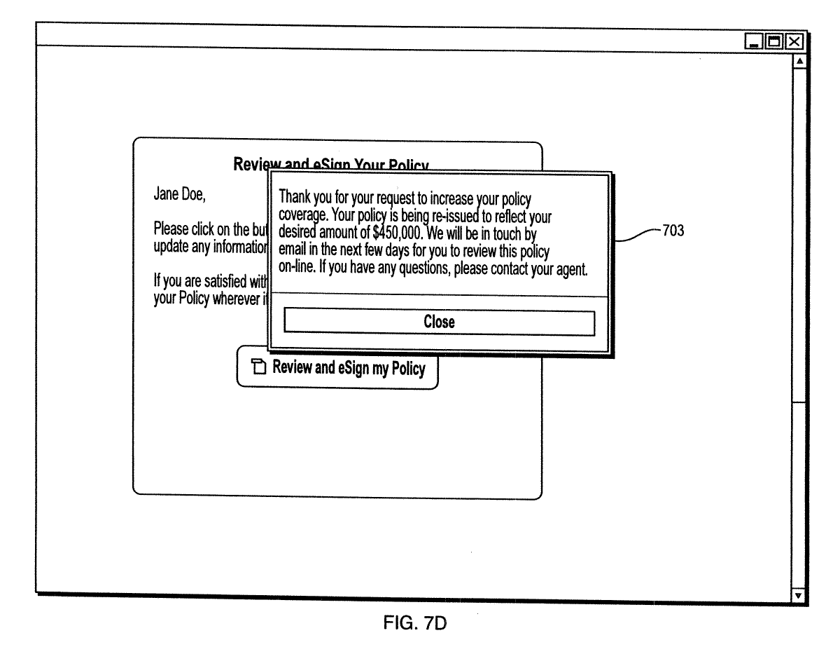

Assuming policy delivery is not suspended based on the consumer's responses to the knockout questions, if any, an upsell screen 701 may be presented to the user in step 204, as shown in FIG. 7A. Upsell screen 701 shows the current term length of the policy and benefit amount. In addition, it informs the consumer that the consumer has qualified and was underwritten for certain policy upgrades and/or additional policy features. Such policy upgrades and/or additional features may include a policy amount increase, additional policy riders, premium changes, and term changes. In certain embodiments, graphical and/or video demonstrations of the available policy upgrades may be employed, such as the slider bar shown with reference to FIGS. 7A and 7B. The policy features and upgrades available to the consumer are obtained from policy storage database (e.g., database 104a) as specified by the carrier by way of a data feed. In particular, a block of data is provided by the carrier for each policy. That block of data is passed through the system and specifies what additional increments, riders and/or product features could be made available to the insured without any additional underwriting. With each increment or feature provided, the premium associated with the additional incremental coverage and/or add on feature is also specified in the data block, as provided by the insurer. If the consumer elects to change his coverage based on one of the presented options, a screen 702 is presented, with reference to FIG. 7C, asking the consumer to confirm his choice and request that his change in coverage be processed. Then, a screen 703 is presented, with reference to FIG. 7D, informing the consumer that his policy is being reissued to reflect the changed coverage, and that he will be receiving an electronic message allowing the consumer to review his policy, with the change reflected, electronically. Thus, the amendment to the policy that is to be reviewed can be created automatically prior to the consumer's policy review.

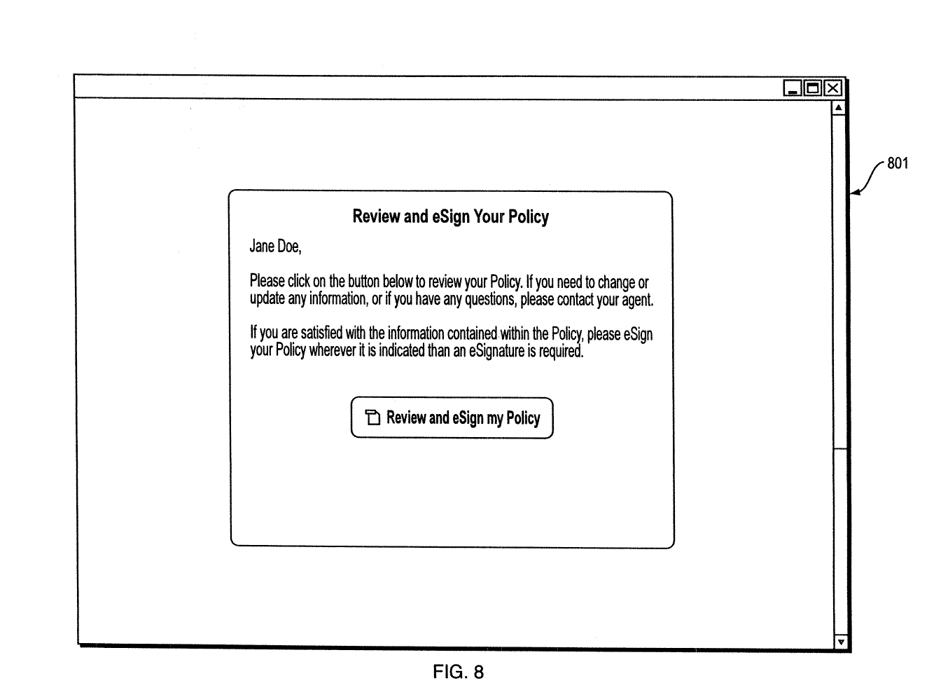

Assuming the consumer does not elect to change his policy to reflect any available policy upgrades, screen 801 of FIG. 8 is presented to the consumer allowing the consumer to access and review his policy electronically in step 205. Or, if the consumer does elect to change his policy, the amended policy is presented to the consumer electronically fore review, in step 205. An electronic signature application is made available to the consumer. The consumer accepts a digital signature representation and reviews his policy document online while electronically signing. The consumer also specifies a payment source to pay for the policy, which is validated.

Finally, in step 206, after successful approval and signing, the consumer is given the option of viewing his signed and completed policy online, which signed and completed policy is stored on or in connection with platform 100 (e.g., in database 104c).

The previously described embodiment is one in which the platform communicates directly with the consumer regarding the consumer's insurance policy. In other embodiments, the insurance policy may be sold to the consumer through an agent and, in still other embodiments, the insurance policy may be sold to the consumer through an agent by way of a distributor. In the embodiments that involve an agent, the electronic policy may first be routed to the agent for electronic approval and signature before forwarding to the consumer. In the embodiments that involve an agent and a distributor, the electronic policy may first be routed to the distributor for review and approval, and then to the agent for electronic approval and signature before forwarding to the consumer.

It will be apparent to those skilled in the art that various modifications and variations can be made in the personal information file management tool of the present invention without departing from the spirit or scope of the invention.

What is claimed is:

1. A computer-implemented method comprising:
storing in one or more databases data regarding an insurance policy, providing insurance coverage, to be presented to a consumer for review and execution;
generating, using a processor, and presenting to the consumer one or more electronic messages indicating that the insurance policy is available for review and inquiring as to whether the consumer agrees to review and execute the policy in electronic form; and
after receiving an electronic indication from the consumer of agreement to review and execute the insurance policy in electronic form, generating, using a processor, and presenting to the consumer in electronic form one or more options for enhancing the insurance coverage without performing any additional underwriting for the policy.

2. The computer-implemented method of claim 1, wherein the insurance coverage comprises an insurance policy term and insurance policy coverage amount and wherein one or more of the one or more options for enhancing the insurance coverage comprises one or both of an increased insurance policy term and an increased insurance policy coverage amount.

3. The computer-implemented method of claim 1, wherein one or more of the one or more options for enhancing the insurance coverage comprise a rider to the insurance policy.

4. The computer-implemented method of claim 1 wherein the one or more options for enhancing the insurance coverage are presented to the consumer using one or both of graphics and video.

5. A system comprising:
one or more databases that store data regarding an insurance policy, providing insurance coverage, to be presented to a consumer for review and execution;
one or more processors that generate and present to the consumer one or more electronic messages indicating that the insurance policy is available for review and inquiring as to whether the consumer agrees to review and execute the policy in electronic form; and after receiving an electronic indication from the consumer of agreement to review and execute the insurance policy in electronic form, generate and present to the consumer in electronic form one or more options for enhancing the insurance coverage without performing any additional underwriting for the policy.

6. The system of claim 5, wherein the insurance coverage comprises an insurance policy term and insurance policy coverage amount and wherein one or more of the one or more options for enhancing the insurance coverage comprises one or both of an increased insurance policy term and an increased insurance policy coverage amount.

7. The system of claim 5, wherein one or more of the one or more options for enhancing the insurance coverage comprise a rider to the insurance policy.

8. The system of claim 5, wherein the one or more options for enhancing the insurance coverage are presented to the consumer using one or both of graphics and video.
